(19) United States
(12) Patent Application Publication
(10) Pub. No.: US 2008/0022072 A1
(43) Pub. Date: Jan. 24, 2008

(54) System, method and medium processing data according to merged multi-threading and out-of-order scheme

(75) Inventors: Seok-yoon Jung, Seoul (KR); Sang-won Ha, Seoul (KR); Do-kyoon Kim, Seongnam-si (KR); Won-jong Lee, Suwon-si (KR); Seung-gi Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/806,981

(22) Filed: Jun. 5, 2007

(30) Foreign Application Priority Data
Jul. 20, 2006 (KR) 10-2006-0068216

(51) Int. Cl. G06F 9/30

(52) U.S. Cl. 712/209; 712/E09.062

(57) ABSTRACT

A system, method and medium performing data operations according to a merged multi-threading and out-of-order scheme. According to the method, at least one instruction is decoded, a thread of an instruction is read based on the decoding result, and a predetermined operation is performed on each of a plurality of threads, including the read thread, in each of a plurality of pipeline stages in an out-of-order manner, based on the decoding result. Accordingly, it is possible to guarantee high throughput while maintaining a small number of threads.

### CROSS-REFERENCE TO RELATED APPLICATIONS

This application claims the priority of Korean Patent Application No. 10-2006-0068216, filed on Jul. 20, 2006, in the Korean Intellectual Property Office, the disclosure of which is incorporated herein in its entirety by reference.

### BACKGROUND

1. Field

One or more embodiments of the present invention relate to a processor that performs a data operation, and more particularly, to a processor that performs a data operation according to a multi-threading scheme.

2. Description of the Related Art

Factors that degrade the system performance in a conventional pipeline system are data dependency, control dependency, resource contention, etc. In order to prevent data dependency and control dependency, execution of an instruction upon which another instruction is dependent must be completed prior to execution of the latter dependent instruction. In the case of data dependency, when the latter dependent instruction is executed right after the execution of the former instruction is completed, the overall pipelines corresponding to a latency of a functional unit must be stalled, thus degrading the system throughput. In the case of control dependency, all the pipelines must be stalled for a cycle time, since a subsequent instruction to be fetched may be learned only when decoding of a specific instruction is completed. In contrast, resource contention occurs when there are a plurality of pipelines and execution of two or more instructions require the same function unit.

FIG. 1 illustrates a processor operating according to a conventional multi-threading scheme. Referring to FIG. 1, the processor includes an instruction memory 101, a register file 102, an input buffer 103, a constant value memory 104, a vector operation unit 105, a scalar operation unit 106, and an output buffer 107.

In general, three-dimensional (3D) graphic data is completely independent and is bulky. In order to efficiently process such data, a multi-threading scheme is used to maximize the system throughput while completely removing data dependency and control dependency. The processor, illustrated in FIG. 1, which operates according to a conventional multi-threading scheme, allocates only one instruction to a function unit (one of the vector operation unit 105 and the scalar operation unit 106) for each cycle, and therefore, resource contention does not occur.

If the multi-threading scheme is used, the maximum throughput can be obtained for all cases when a sufficient number of threads are maintained. The multi-threading scheme uses data parallelism, not the instruction-level parallelism (ILP) used by most microprocessors. That is, in the multi-threading scheme, a subsequent piece of data is not processed after processing a piece of data. Instead, an instruction is circularly applied to a plurality of pieces of data, a subsequent instruction is circularly applied to the pieces of data after all the pieces of data are processed according to the former instruction, and this process is repeatedly performed.

The multi-threading scheme has an advantage of guaranteeing the maximum throughput as described above. However, in order to guarantee the maximum throughput, the number of threads must be maintained according to a latency of the function unit, such as the vector operation unit 105 or the scalar operation unit 106, as such an increase in the sizes of the input buffer 103 and the output buffer 107 that store threads is required. If the latency of the function unit of a processor that processes 3D graphic data, for example, is significantly increased, a very large capacity input buffer and output buffer are needed, thereby increasing the manufacturing costs of a register that includes the input buffer and the output buffer.

FIG. 2 is a block diagram of a processor operating according to a conventional out-of-order scheme. Referring to FIG. 2, the processor includes a fetch unit 201, a decoding unit 202, a register file 203, a tag unit 204, reservation stations 205, a functional unit 206, a load register 207, and a memory 208.

Most of the conventional microprocessors execute instructions in an order that is different than the original order. Eventually, this respectively fills all pipelines with instructions that are not related to one another at a specific instant of time, when a plurality of pipelines are present as in a superscalar scheme. If an operation is performed according to an instruction based on the result of an operation performed according to another instruction, a pipeline occupied by the former operation cannot perform any operation according to the former instruction and must stand by until the performing of the operation according to the latter instruction, upon which the former instruction is dependent, is complete. Thus, inserting an instruction that depends on another instruction into a pipeline is suspended, and instructions that do not depend on any instruction are respectively detected and inserted into the pipelines in order to operate all pipelines without an intermission. As described above, execution of an instruction that depends on another instruction is temporarily suspended and later continued, thus causing the instruction to be executed in an order different than the original order, which is referred to as the out-of-order scheme that has been suggested.

The processor illustrated in FIG. 2 is an extension of a classical Tomasulo algorithm, which is particularly described in an article titled “Instruction Issue Logic for High-Performance, Interruptible, Multiple Functional Unit, Pipelined Computers”, (IEEE transactions on computers, vol. 39, March 1990). However, the processor illustrated in FIG. 2 has a disadvantage in that it is significantly difficult to detect a sufficient number of independent instructions that are not related to instructions that are being currently processed or that are to be processed in a very short time. The more pipelines there are, the more serious this problem becomes.

### SUMMARY

One or more embodiments of the present invention provide a system, method and medium processing data according to a merged multi-threading and out-of-order scheme having both the advantages of the multi-threading scheme and the out-of-order scheme, and which can achieve maximum performance against cost.

One or more embodiments of the present invention provide a processing system, method and medium for attaining high throughput while maintaining a small number of threads in order to reduce the manufacturing costs of a register that includes an input buffer and an output buffer.

One or more embodiments of the present invention also provide a computer readable medium having recorded thereon a computer program for executing the method.

Additional aspects and/or advantages of the invention will be set forth in part in the description which follows and, in part, will be apparent from the description, or may be learned by practice of the invention.

To achieve at least the above and/or other aspects and advantages, embodiments of the present invention include a merged multi-threading and out-of-order processing method comprising decoding at least one instruction, and reading a thread of the instruction based on the decoding result, and performing a predetermined operation on each of a plurality of threads, including the read thread, in each of a plurality of pipeline stages in an out-of-order manner, based on the decoding result.

To achieve at least the above and/or other aspects and advantages, embodiments of the present invention include a computer readable medium having recorded thereon a computer program for executing a processing method.

To achieve at least the above and/or other aspects and advantages, embodiments of the present invention include a merged multi-threading and out-of-order processing system comprising a decoding unit to decode at least one instruction, and reading a thread of the instruction based on the decoding result, and an operation unit to perform a predetermined operation on each of a plurality of threads, including the read thread, in each of a plurality of pipeline stages in an out-of-order manner, based on the decoding result.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a processor operating according to a conventional multi-threading scheme;

FIG. 2 illustrates a processor operating according to a conventional out-of-order scheme;

FIG. 3 illustrates a system for processing based on a merged multi-threading and out-of-order scheme, according to an embodiment of the present invention;

FIG. 4 illustrates the construction of an instruction pipeline, such as used by the system of FIG. 3, according to an embodiment of the present invention;

FIG. 5 illustrates the construction of an operating pipeline according to a conventional multi-threading scheme;

FIG. 6 illustrates the construction of an operating pipeline according to a merged multi-threading and out-of-order scheme according to an embodiment of the present invention;

FIGS. 7A through 7D illustrate a method for processing based on a merged multi-threading and out-of-order scheme, according to an embodiment of the present invention;

FIG. 8 illustrate the total number of 1-bit registers needed in various operation pipeline configurations;

FIG. 9 illustrate the averaged system throughput in each of the various operation pipeline configurations; and

FIG. 10 illustrate the system performance against cost for each of the various operation pipeline configurations.

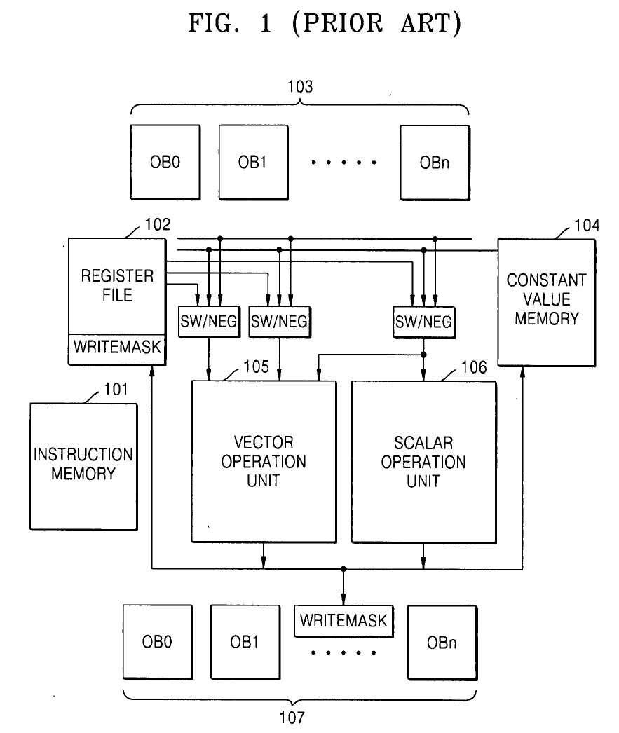

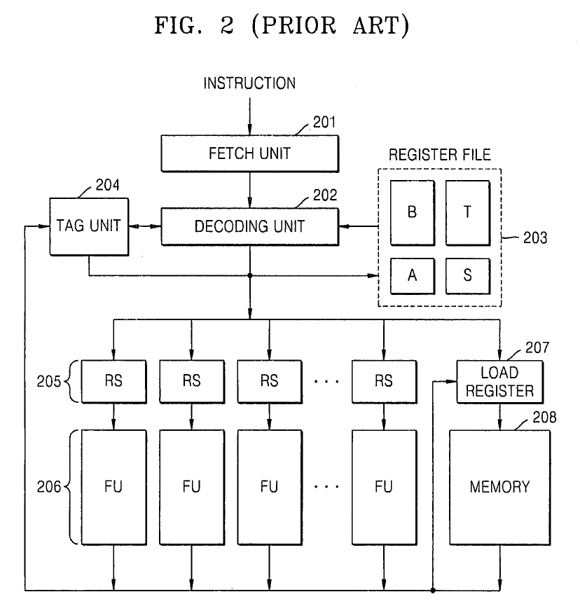

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

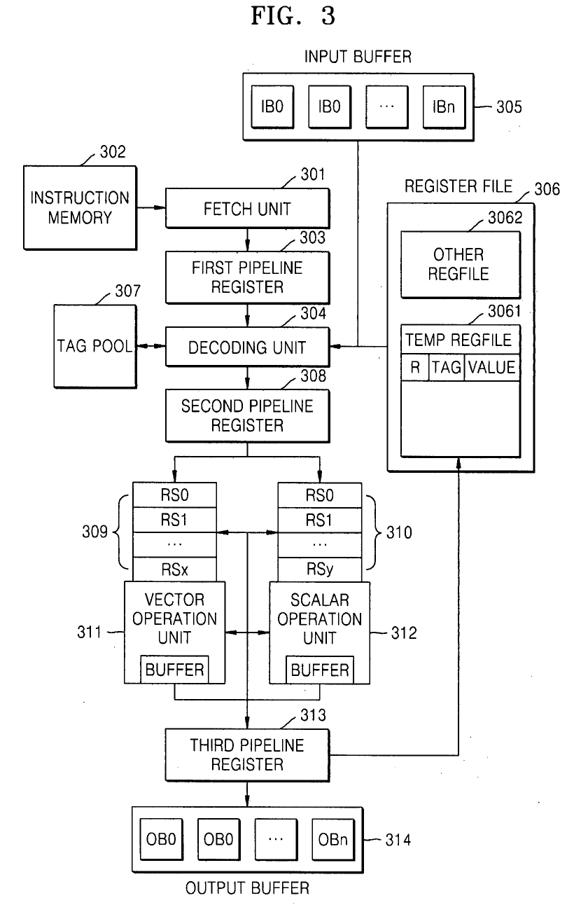

FIG. 3 is a block diagram of a system for processing based on a merged multi-threading and out-of-order scheme, according to an embodiment of the present invention. Referring to FIG. 3, the system may include, for example, a fetch unit 301, an instruction memory 302, a first pipeline register 303, a decoding unit 304, an input buffer 305, a register file 306, a tag pool 307, a second pipeline register 308, a first reservation station 309, second reservation station 310, a vector operation unit 311, a scalar operation unit 312, a third pipeline register 313, and an output buffer 314. In particular, in an embodiment, it is assumed that a plurality of threads are a plurality of pieces of independent data that are not related to one another, e.g., 3D graphic data.

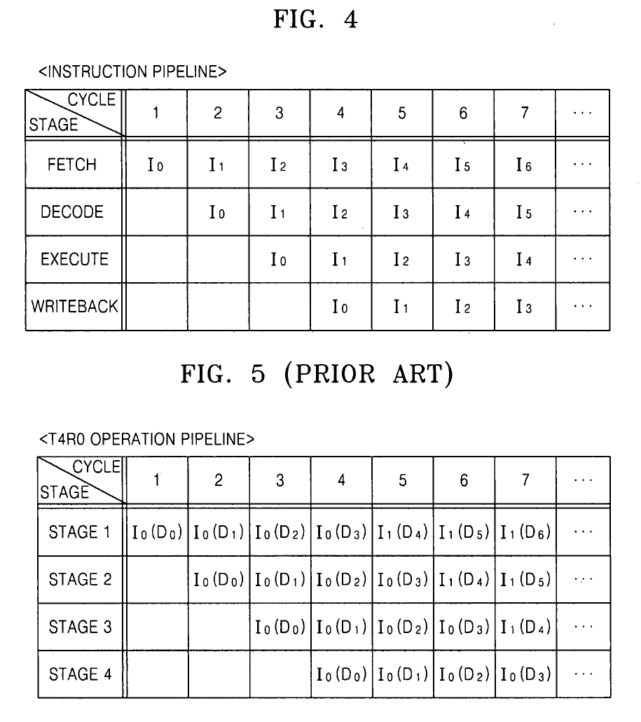

FIG. 4 is a table illustrating the construction of an instruction pipeline used by the system for processing according to a merged multi-threading and out-of-order scheme, which is illustrated in FIG. 3. Referring to FIG. 4, the instruction pipeline may consist of four pipeline stages: a fetching stage, a decoding stage, an execution stage, and a writeback stage. In the system for example, an instruction I₀ is fetched in a first cycle. Next, an instruction I₁ is fetched and the already fetched instruction I₀ is decoded in a second cycle. Next, an instruction I₂ is fetched, the already fetched instruction I₁ is decoded, and the already decoded instruction I₀ is executed in a third cycle. Thereafter, an instruction I₃ is fetched, the already fetched instruction I₂ is decoded, the already decoded instruction I₁ is executed, and the already executed instruction I₀ is written in a fourth cycle. Accordingly, a pipelined system for processing according to the merged multi-threading and out-of-order scheme may be capable of completing fetching, decoding, executing, and writing of an instruction for a cycle, thereby maximizing the instruction throughput.

Each element of the above instruction-pipelined processing system according to the merged multi-threading and out-of-order scheme will now be described in greater detail with reference to FIG. 3.

The fetch unit 301 may fetch at least one instruction from the instruction memory 302 and store the fetched instruction in the first pipeline register 303 during each cycle. The better the performance of the processing system, the more instructions that the fetch unit 301 may fetch during each cycle.

During each cycle, the decoding unit 304 may decode at least one of the instructions fetched by the fetch unit 301 (e.g., the instructions stored in the first pipeline register 303), and select one of the vector operation unit 311 and the scalar operation unit 312 as the operation unit which will perform an operation on the fetched instructions, based on the decoding result. Specifically, when the decoding result shows that a vector operation is to be performed on the at least one instruction, the decoding unit 304 may select the vector operation unit 311 as an operation unit. If the decoding result shows that a scalar operation is to be performed on the at least one instruction, the decoding unit 304 may select the scalar operation unit 312 as an operation unit. The better the hardware performance of the system illustrated in FIG. 3, the more instructions the decoding unit 304 may decode during each cycle.

Next, the decoding unit 304 may check whether at least one reservation station connected to the selected vector operation unit 311 or scalar operation unit 312 is in use, and secure a reservation station that is not in use, based on the result of the checking.

Also, the decoding unit 304 may read at least one source operand corresponding to a thread of the instruction from the input buffer 305 or the register file 306, based on the result of decoding, and store the read source operand in the second pipeline register 308. If the source operand is read from the input buffer 305, the decoding unit 304 may store the read source operand in the secured reservation station. Here, a value T (true), indicating that the source operand is ready to perform a predetermined operation, may also be stored in a preparation field of the reservation station. In an embodiment, the preparation field may record a value indicating whether a source operand is ready to perform a predetermined operation, that is, whether the value of a source operand is altered by the value of a destination operand of a different instruction. In this disclosure, although the source operand and the value T may be actually stored via the second pipeline register 308, the decoding unit 304 may be described as storing them directly in the reservation station, for convenience of explanation.

The decoding unit 304 may store a value indicating that the source operand is stored in the secured reservation station and a value indicating an operation that is to be performed on the source operand, as would be apparent to those of ordinary skill in the art.

If the source operand is read from a temporary register file 3061 of the register file 306, on which a plurality of read and write operations may be performed, the value of the source operand may later be altered. Thus, the decoding unit 304 may read the source operand, and also read values stored in a preparation field and a tag field of a register storing the source operand, and may store the read source operand and values.

The register file 306 may include the temporary register file 3061, on which a plurality of read and write operations may be performed, and another register file 3062, on which only read operations may be performed. Since only read operations may be performed on the register file 3062, a source operand read from the register file 3062 may be processed as described above, similarly to a source operand read from the input buffer 305.

Also, the decoding unit 304 may determine whether a destination operand of an instruction is stored in the temporary register file 3061, based on the result of decoding the instruction. If the determination result shows that the destination operand of the instruction is stored in the temporary register file 3061, the decoding unit 304 may allocate one of a plurality of unused tags stored in the tag pool 307 to a register storing the destination operand, and store the value of a preparation field of the register as a value F (false) indicating that a source operand whose value is set to the value of the destination operand is not yet ready to perform a predetermined operation.

Here, the tag may be used to simply substitute an integral index, such as No. 1, 2, or 3, for the physical address of the register. Since a read/write operation is performed on a plurality of destination operands in the register, it may be difficult to identify an operand using the physical address corresponding to an index of the register. Thus, in an embodiment, different tags may be allocated to destination operands so as to solve the above problem.

FIG. 5 is a table illustrating the construction of an operation pipeline according to a conventional multi-threading scheme. Referring to FIG. 5, the pipeline consists of four pipeline stages. In FIG. 5, “T4R0” denotes that there are four threads and no reservation station, that is, it means that the pipeline is used according to the conventional multi-threading scheme to which the out-of-order scheme is not applied. Each of the four pipeline stages may be an adder, a multiplier or the like, which completes an operation within a cycle. The instruction pipeline illustrated in FIG. 4 is designed based on a premise that each of the pipeline stages is completed within a cycle. However, in particular, an execution stage of the pipeline stages generally requires several cycles. Thus, according to the conventional multi-threading scheme, an operation is simultaneously performed on several threads to hide such a latency of the execution stage.

Specifically, in a first cycle, a first-stage operation is performed on a source operand D₀according to an instruction I₀. In a second cycle, the first-stage operation is performed on a source operand D₁ and a second-stage operation is performed on the source operand D₀, according to the instruction I₀. In a third cycle, the first-stage operation is performed on a source operand D₂, the second-stage operation is performed on the source operand D₁, and a third-stage operation is performed on the source operand D₀, according to the instruction I₀. In a fourth cycle, the first-stage operation is performed on a source operand D₃, the second-stage operation is performed on the source operand D₂, the third-stage operation is performed on the source operand D₁, and a fourth-stage operation is performed on the source operand D₀, according to the instruction I₀. Consequently, according to the operation pipeline, the conventional multi-threading scheme allows an execution stage to be completed within a cycle, thereby maximizing the operation throughput.

Although the conventional multi-threading scheme may sometimes provide maximum throughput, it requires a number of threads to be maintained corresponding to a latency of an execution stage. That is, the conventional multi-threading scheme needs input buffers and output buffers corresponding to the total number of stages of an operation pipeline. However, since the latency of the execution stage is significantly large, a very large capacity of input buffers and output buffers is needed, thus significantly increasing the manufacturing costs of a register that includes input buffers and output buffers. Thus, an operation pipeline according to a merged multi-threading and out-of-order scheme, according to an embodiment of the present invention has been suggested by the inventors of the present invention, in order to solve this problem.

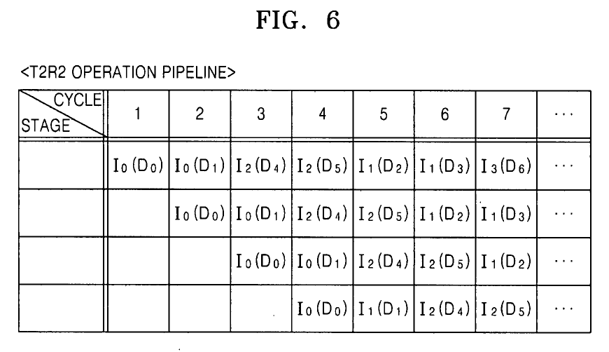

FIG. 6 is a table illustrating the construction of an operation pipeline according to a merged multi-threading and out-of-order scheme, according to an embodiment of the present invention. Referring to FIG. 6, the operation pipeline may consist of four pipeline stages. In FIG. 6, “T2R2” may denote that there are two threads and two reservation stations, that is, it may mean that both the multi-threading scheme and the out-of-order scheme may be used, according to an embodiment of the present invention. Each of the four pipeline stages may be an adder or a multiplier that may complete an operation within a cycle. In general, in a multi-threading scheme, when the total number of input buffers and output buffers may be smaller than the total number of stages of an operation pipeline, the amount of data (the number of source operands) to be processed at a time may be less than in the operation pipeline illustrated in FIG. 5. Therefore, instructions may be changed more frequently than in the operation pipeline illustrated in FIG. 5, and thus, pipelines frequently may stall due to data dependency.

Accordingly, in an embodiment, the multi-threading scheme and the out-of-order scheme may be merged to prevent pipelines from stalling due to an insufficient number of input buffers. That is, in a first cycle, a first-stage operation may be performed on a source operand D₀ according to an instruction I₀. In a second cycle, the first-stage operation may be performed on a source operand D₁ and a second-stage operation may be performed on a source operand D₀, according to the instruction I₀.

In a third cycle, the first-stage operation may be performed on a source operand D₄ according to an instruction I₂, and the second-stage operation may be performed on the source operand D₁ and a third-stage operation may be performed on the source operand D₀, according to the instruction I₀. In a fourth cycle, the first-stage operation may be performed on a source operand D₅ and the second-stage operation may be performed on a source operand D₄, according to an instruction I₂, and the third-stage operation may be performed on the source operand D₁ and a fourth-stage operation may be performed on the source operand D₀, according to the instruction I₀. Here, the reason the instruction I₂, instead of an instruction I₁, may have been given after the instruction I₀ in the third and fourth cycles is because source operands D₂ and D₃ of the instruction I₁ may depend on a destination operand according to the instruction I₀.

Hereinafter, the vector operation unit 311 and the scalar operation unit 312 that may operate based on an operation pipeline according to the above merged multi-threading and out-of-order scheme, will be described in greater detail.

When the vector operation unit 311 is selected as an operation unit to be used according to an instruction decoded by the decoding unit 304, the vector operation unit 311 may perform at least one vector operation on each of a plurality of threads that may include a thread read by the decoding unit 304 (the threads may be stored in the second pipeline register 308) in each of a plurality of pipeline stages for each cycle, in an out-of-order manner. The better the hardware performance of a system for processing based on the merged multi-threading and out-of-order scheme, according to an embodiment, the more vector operations the vector operation unit 311 may perform for each cycle.

More specifically, the vector operation unit 311 may first perform a vector operation on one of the threads including the thread read by the decoding unit 304, which may not be dependent on a thread that has not yet been processed in one of the pipeline stages. In an embodiment of the present invention, the threads may include a thread of an instruction decoded by the decoding unit 304 and a thread of another instruction that may have been previously decoded by the decoding unit 304.

The above operation of the vector operation unit 311 may be performed in the following manner. The vector operation unit 311 may check whether a value of a preparation field of at least one reservation station 309, which typically stores a source operand corresponding to a thread of an instruction, may indicate that the source operand is ready to perform a vector operation, while at the at least one first reservation station 309, and may perform a vector operation on each of a plurality of threads in an out-of-order manner, based on the result of checking. In particular, if the at least one first reservation station 309 includes a plurality of reservation stations, it may mean that there is another reservation station that stores a source operand included in a thread different to the thread including the source operand. Here, the value of the preparation field may indicate whether the value of a source operand stored in a reservation station may be changed by the value of a destination operand of a different instruction.

If the result of checking the value of the preparation field shows that the value of the source operand stored in the reservation station is not changed by the value of the destination operand of the different instruction, the vector operation unit 311 may perform the vector operation on the source operand stored in the reservation station. If the result of checking the value of the preparation field shows that the value of the source operand is changed by the value of the destination operand of the different instruction, the vector operation unit 311 may not need to perform the vector operation on the source operand. In this way, the vector operation unit 311 may first perform the vector operation on one of a plurality of threads, which is not dependent upon a thread that has yet to be processed in one of the pipeline stages.

Next, a write operation may be performed. Specifically, when the result of the above processing shows that the destination operand is stored in the output buffer 314, the vector operation unit 311 may store the value of the destination operand in the output buffer 314 via the third pipeline register 313. If the destination operand is stored in the temporary register file 3061, the vector operation unit 311 may update the value of a source operand stored in a reservation station whose tag is the same as the tag of the destination operand, which is recorded in the tag field of the reservation station storing the source operand for the destination operand, with the value of the destination operand, and may update the value recorded in a preparation field of the reservation station with a value indicating that the value of the source operand stored in the reservation station has not been changed by the value of a destination operand of another instruction. At the same time, in the temporary register file 3061, the vector operation unit 311 may update the value of a source operand, which is stored in a register and may have the same tag as the destination operand corresponding to the above processing result, with the value of the destination operand; and may update a preparation field of the register with a value indicating that the value of the source operand stored in the reservation station has not been changed by the value of a destination operand of another instruction. The vector operation may first be performed on a source operand processed as described above according to the out-of-order scheme, and the vector operation unit 311 may return the above tag to the tag pool 307 since the tag may no longer be needed.

When the scalar operation unit 312 is selected as the operation unit to perform an operation according to an instruction decoded by the decoding unit 304, the scalar operation unit 312 may perform at least one scalar operation on a plurality of threads, which may include the thread read by the decoding unit 304, in an out-of-order manner in each of a plurality of pipeline stages during each cycle. The better the hardware performance of the system for processing based on the merged multi-threading and out-of-order scheme according to an embodiment, the more scalar operations that the scalar operation unit 312 may perform within a cycle. The function of the scalar operation unit 312 may be the same as those of the vector operation unit 311 except the manner of operation, and thus, a further detailed description of the scalar operation unit 312 will be omitted. A buffer included in each of the vector operation unit 311 and the scalar operation unit 312 may prevent bus contention from occurring during a write operation.

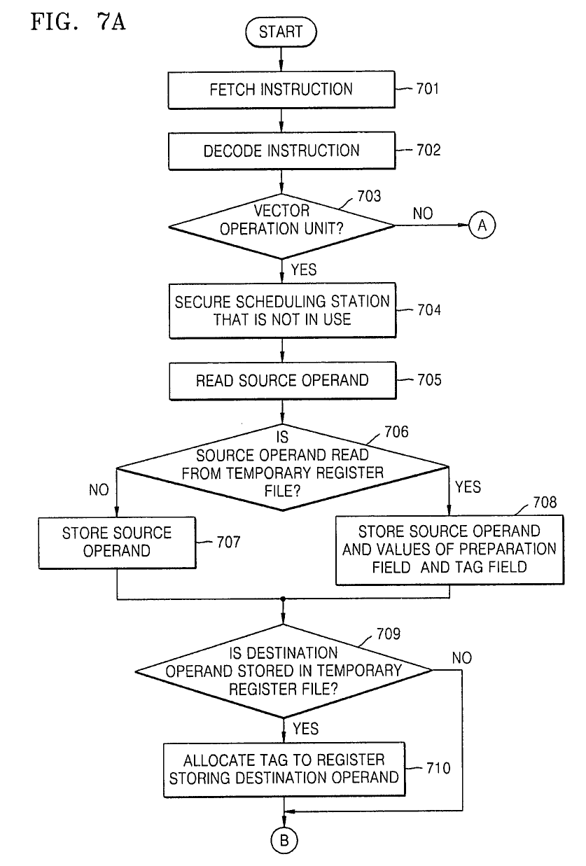

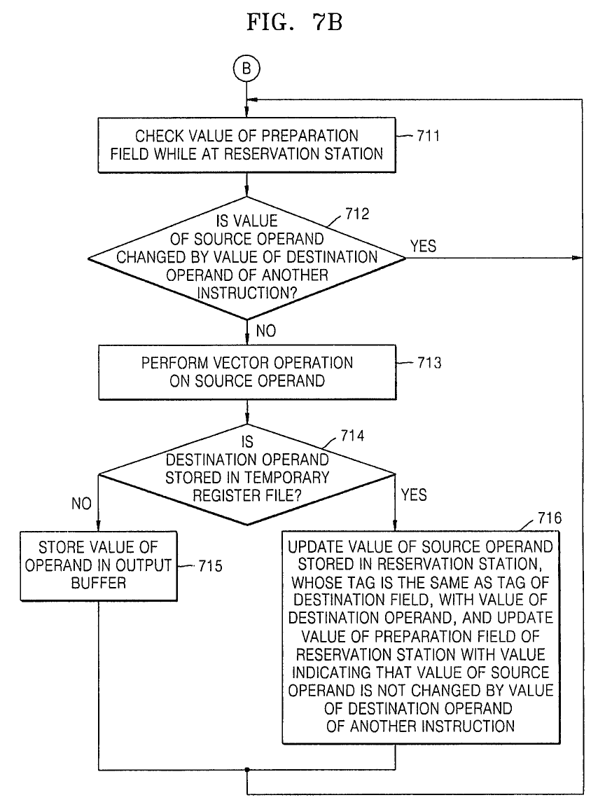

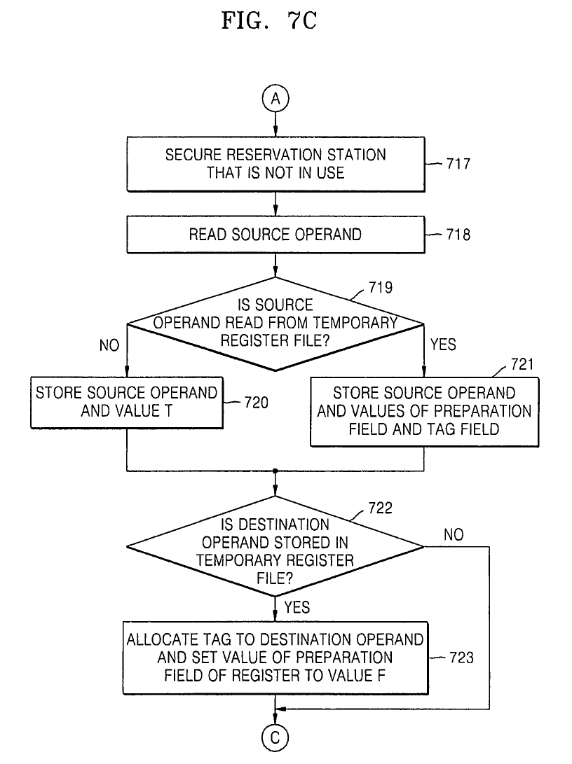

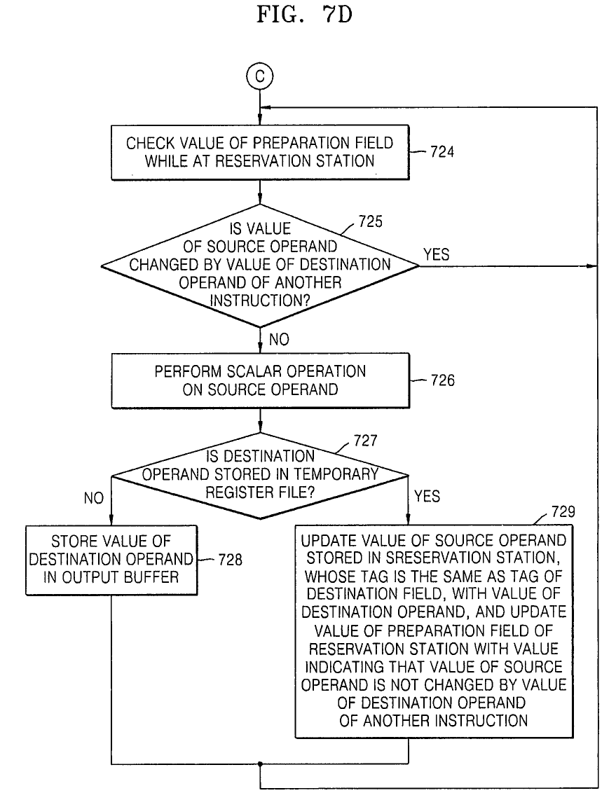

FIGS. 7A through 7D illustrate a method of processing based on a merged multi-threading and out-of-order scheme, according to an embodiment of the present invention. The method illustrated in FIGS. 7A through 7D may include timing operations performed by a system, such as illustrated in FIG. 3, for processing according to the merged multi-threading and out-of-order scheme. Therefore, although not described here, the description of the system of FIG. 3 may be applicable to the method of FIGS. 7A through 7D.

In operation 701, the system may fetch at least one instruction, e.g., from the instruction memory 302, during each cycle.

In operation 702, the system may decode instructions including the instruction fetched in operation 701 in each cycle, and select one of the vector operation unit 311 and the scalar operation unit 312 as the operation unit for performing an operation according to the fetched instruction, based on the decoding result.

In operation 703, the system may proceed to operation 704 if the vector operation unit 311 is selected in operation 702, and proceed to operation 718 if the scalar operation unit 312 is selected in operation 702.

In operation 704, the system may check whether one or more reservation stations connected to the vector operation unit 311 selected in operation 702 are in use, and obtain a reservation station that is not in use, based on the result of checking.

In operation 705, the system may read at least one source operand corresponding to a thread of the instruction from the input buffer 305 or the register file 306, based on the result of decoding obtained in operation 702.

In operation 706, the system may proceed to operation 707 if the source operand was read from the input buffer 305 in operation 705, and proceed to operation 708 if the source operand was read from the temporary register file 3061.

In operation 707, the system may store the read source operand in the reservation station secured in operation 704, and also store a value T indicating that the source operand is ready to perform a predetermined operation in a preparation field of the reservation station.

In operation 708, the system may read the values of a preparation field and a tag field of a register storing the source operand, store the source operand in the reservation station secured in operation 704, and also store the read values of the preparation field and the tag field.

In operation 709, the system may determine whether a destination operand of the instruction is in the temporary register file 3061, based on the decoding result in operation 702, proceed to operation 710 if the determination result shows that the destination operand of the instruction is stored in the temporary register file 3061, and proceed to operation 711 otherwise.

In operation 710, the system may allocate one of a plurality of unused tags, which are stored in the tag pool 307, to the register storing the destination operand of the instruction, and store the value of a preparation field of the register as a value F indicating that the source operand whose value is set to the value of the destination operand has yet to be ready to perform a vector operation.

In operation 711, the system may check the value of a preparation field of a reservation station storing a source operand corresponding to a thread of an instruction in order to determine whether the source operand is ready to perform the vector operation, while visiting the first reservation station 309 or more.

In operation 712, the system may proceed to operation 703 when the checking result in operation 711 shows that the value of the source operand stored in the reservation station has not been changed by the value of a destination operand of another instruction, and return back to operation 711 otherwise.

In operation 713, the system may perform the vector operation on the source operand stored in the reservation station.

In operation 714, the system may proceed to operation 715 when the result of performing the vector operation in operation 713 shows that the destination operand is stored in the output buffer 314, and proceed to operation 716 when the result shows that the destination is stored in the temporary register file 3061.

In operation 715, the system may store the value of the destination operand, which is obtained by performing the vector operation in operation 713, in the output buffer 314, and then return back to operation 711.

In operation 716, the system may update the value of a source operand stored in a reservation station whose tag is the same as that tag of the destination operand, which corresponds to the result of performing the vector operation in operation 713, with the value of the destination operand; and update the value of the preparation field of the reservation station with a value indicating that the value of the source operand stored in the reservation station has not been changed by a destination operand of another instruction. At the same time, in operation 716, the system may update the value of source operand, which is stored in a register whose tag is the same as the tag of the destination operand corresponding to the result of performing the vector operation, with the value of the destination operand in the temporary register file 3061; update the value of a preparation field of the register with the value indicating the value of the source operand stored in the reservation station has not been changed by the value of a destination operand of another instruction; and return back to operation 711.

In operation 717, the system may check whether one or more reservation stations connected to the scalar operation unit 312 selected in operation 702 are in use, and secure one of the reservation stations that are not in use, based on the checking result.

In operation 718, the system may read at least one source operand corresponding to a thread of the instruction from the input buffer 305 or the register file 306, based on the decoding result in operation 702.

In operation 719, the system may proceed to operation 720 when the source operand is read from the input buffer 305 in operation 718, and proceed to operation 721 when the source operand is read from the register file 306.

In operation 720, the system may store the source operand in the reservation station secured in operation 717, and store a value T indicating that the source operand is ready to perform a scalar operation in a preparation field of the reservation station.

In operation 721, the system may read the values of a preparation field and a tag field of a register storing the source operand, store the source operand in the reservation station secured in operation 717, and also store the read values of the preparation field and the tag field.

In operation 722, the system may determine whether the destination operand of the instruction is stored in the temporary register file 3061, based on the decoding result in operation 702, proceed to operation 723 when the determination result shows that the destination operand of the instruction is stored in the temporary register file 3061, and proceed to operation 724 otherwise.

In operation 723, the system may allocate one of a plurality of unused tags stored in the tag pool 307 to the destination operand, and set the value of the preparation field of the register storing the destination operand of the instruction to a value F indicating that a source operand whose value is set to the value of the destination operand is not yet ready to perform the scalar operation.

In operation 724, the system may check the value of a preparation field of a reservation station storing a source operand corresponding to a thread of an instruction in order to determine whether the source operand is ready to perform the scalar operation, while at the first reservation station 309 or more.

In operation 725, the system may proceed to operation 726 if the result of checking in operation 724 shows that the value of the source operand stored in the reservation station has not been changed by the value of a destination operand of another instruction, and proceed to operation 717 otherwise.

In operation 726, the system may perform the scalar operation on the source operand stored in the reservation station.

In operation 727, the system may proceed to operation 728 if the result of performing the scalar operation in operation 726 shows that the destination operand is stored in the output buffer 314, and proceed to operation 729 if the result of performing the scalar operation shows that the destination operand is stored in the temporary register file 3061.

In operation 728, the system may store the value of the destination operand obtained by performing the scalar operation in operation 726 in the output buffer 314, and return to operation 717.

In operation 729, the system may update the value of a source operand stored in a reservation station, whose tag is the same as the tag of the destination field, with the value of the destination operand (the tag of the destination field corresponds to the result of performing the scalar operation in operation 726, e.g., the value recorded in the tag field of the reservation station storing the source operand for the destination operand); and may update the value of a preparation field of the reservation station with a value indicating that the value of the source operand stored in the reservation station has not been changed by the value of a destination operand of another instruction. At the same time, in operation 729, the system may update the value of a source operand stored in a register, whose tag is the same as the tag of the destination operand (which correspond to the result of performing the scalar operation), with the value of the destination operand in the temporary register file 3061, may update the value of a preparation field of the register with a value indicating that the value of the source operand stored in the reservation station has not been changed by the value of a destination operand of another instruction, and return to operation 717.

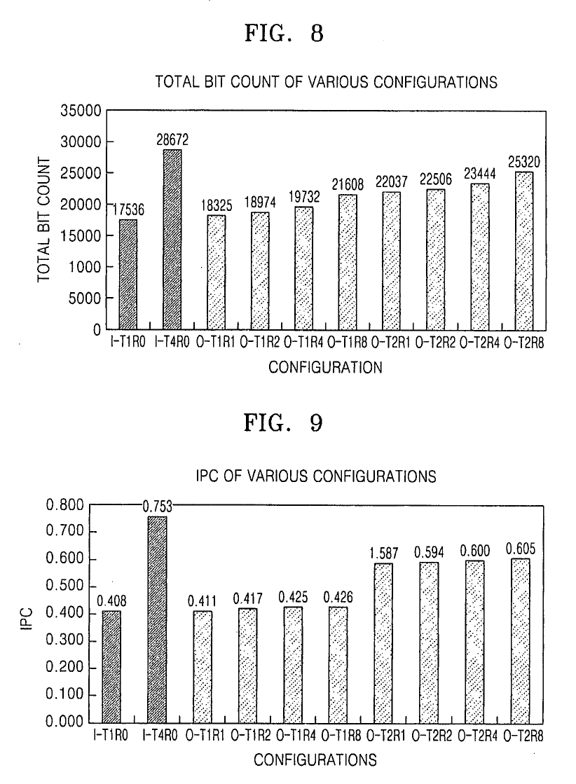

FIG. 8 illustrates the total number of 1-bit registers that may be needed in various types of operation pipeline configurations. Referring to FIG. 8, the second bar on the left side of the graph may represent the total number of 1-bit registers in a “T4R0” configuration. Here, “T4R0” denotes that there are four threads and no reservation station, that is, a conventional multi-threading scheme may be used, to which the out-of-order scheme is typically not applied. Each of the bars on the right side of the second bar represents a total number of 1-bit registers in a pipeline configuration, in which one or two threads may be maintained and to which the out-of-order scheme may be applied. As illustrated in FIG. 8, a pipeline configuration, in which the largest number of threads are maintained, may require the largest number of 1-bit registers.

FIG. 9 illustrates the averaged system throughput in each of the various types of operation pipeline configurations. Referring to FIG. 9, a second bar on the left side of the graph represents the averaged throughput in a “T4R0” configuration. Here, “T4R0” denotes that there are four threads and no reservation station, that is, a conventional multi-threading scheme may be used, to which the out-of-order scheme is typically not applied. In contrast, the bars on the right side of the second bar represent the averaged throughput in a pipeline configuration, in which one or two threads may be maintained and to which the out-of-order scheme may be applied. As illustrated in FIG. 9, a pipeline configuration in which the largest number of threads are maintained may bring out the maximum throughput. However, the fewer the number of threads, the more the throughput of a pipeline configuration, to which the out-of-order scheme may be applied, may approximate the maximum throughput.

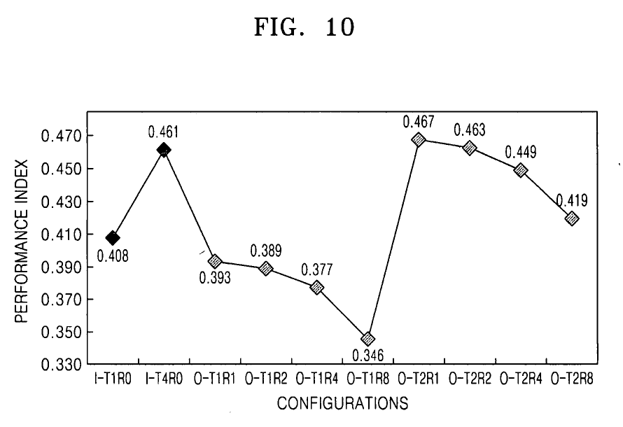

FIG. 10 illustrates the system performance against cost for each of the various types of operation pipeline configurations. The value of each bar illustrated in FIG. 10 may be obtained by dividing the total number of 1-bit registers needed in each pipeline configuration illustrated in FIG. 8 by the corresponding averaged throughput illustrated in FIG. 9, and the obtained value may be indicated with a performance index representing performance against cost. As illustrated in FIG. 9, although the multi-threading scheme capable of maintaining a large number of threads may bring out the maximum throughput, it is not practical to use the throughput as an evaluation criterion without considering hardware costs. This is because the value of technique represents marketability, and therefore, both hardware costs and system performance must be considered.

In particular, FIG. 10 reveals that the bar corresponding to a configuration “T2R1” shows the maximum performance against cost. Accordingly, the conventional multi-threading scheme may sometimes have advantages over a merged multi-threading and out-of-order scheme according to embodiments of the present invention in terms of performance since it may maintain a larger number of threads, but the merged multi-threading and out-of-order scheme, according to embodiments of the present invention, is superior to the conventional multi-threading scheme when both performance and hardware costs are considered.

In addition to the above described embodiments, embodiments of the present invention may also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code may be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A merged multi-threading and out-of-order processing method comprising:
decoding at least one instruction, and reading a thread of the instruction based on the decoding result; and
performing a predetermined operation on each of a plurality of threads, including the read thread, in each of a plurality of pipeline stages in an out-of-order manner, based on the decoding result.

2. The method of claim 1, wherein the threads comprise the thread of the instruction and a thread of a different instruction.

3. The method of claim 1, wherein during the performing of the predetermined operation, the predetermined operation is first performed on one of the threads, which is not dependent on a thread of the threads that have not yet been processed in one of the pipeline stages.

4. The method of claim 3, wherein, when a source operand corresponding to the thread is not changed by a destination operand of a different instruction, during the performing of the predetermined operation, the predetermined operation is performed on the source operand in order to first perform the predetermined operation on one of the threads, which is not dependent on a thread that has not yet been processed in one of the pipeline stages.

5. The method of claim 1, wherein during the decoding of the at least one instruction, a source operand corresponding to the read thread, and a value indicating that the source operand is ready to perform the predetermined operation are stored in a reservation station, and
during the performing of the predetermined operation, the value is checked while in at least one reservation station including the reservation station, and the predetermined operation is performed on each of the threads in the out-of-order manner, based on the result of the checking.

6. The method of claim 5, wherein, when the at least one reservation station indicates a plurality of reservation stations, the at least one reservation station further comprises a reservation station which stores a source operand corresponding to a different thread, which is not the thread including the source operand.

7. The method of claim 5, wherein the value indicates whether a value of the source operand stored in the reservation station is changed by a value of a destination operand of a different instruction.

8. At least one medium comprising computer readable code to control at least one processing element in a computer to implement a method for a merged multi-threading and out-of-order processing method, the method comprising:
decoding at least one instruction, and reading a thread of the instruction based on the decoding result; and
performing a predetermined operation on each of a plurality of threads, including the read thread, in each of a plurality of pipeline stages in an out-of-order manner, based on the decoding result.

9. A merged multi-threading and out-of-order processing system comprising:
a decoding unit to decode at least one instruction, and reading a thread of the instruction based on the decoding result; and
an operation unit to perform a predetermined operation on each of a plurality of threads, including the read thread, in each of a plurality of pipeline stages in an out-of-order manner, based on the decoding result.

10. The system of claim 9, wherein the threads comprise the thread of the instruction and a thread of a different instruction.

11. The system of claim 10, wherein the operation unit first performs the predetermined operation on one of the threads, which is not dependent on a thread of the threads that have not yet been processed in one of the pipeline stages.

12. The system of claim 11, wherein, when a source operand corresponding to the thread is not changed by a destination operand of a different instruction, the operation unit performs the predetermined operation on the source operand in order to first perform the predetermined operation on the thread which is not dependent on a thread that has not yet been processed in one of the pipeline stages.

13. The system of claim 9, wherein the decoding unit stores a source operand corresponding to the read thread, arid a value indicating that the source operand is ready to perform the predetermined operation in a reservation station, and
the operation unit checks the value while in at least one reservation station including the reservation station, and perform the predetermined operation on each of the threads in the out-of-order manner, based on the result of the checking.

14. The system of claim 13, wherein, when the at least one reservation station indicates a plurality of reservation stations, the at least one reservation station further comprises a reservation station which stores a source operand corresponding to a different thread, which is not the thread including the source operand.

15. The system of claim 13, wherein the value indicates whether a value of the source operand stored in the reservation station is changed by a value of a destination operand of a different instruction.
